(19) United States
(12) Patent Application Publication
(10) Pub. No.: US 2008/0118798 A1
(43) Pub. Date: May 22, 2008

(54) Fuel cell system apparatus

(76) Inventor: Emerson R. Gallagher, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/601,602

(22) Filed: Nov. 17, 2006

(51) Int. Cl. H01M 8/04

(52) U.S. Cl. 429/23

(57) ABSTRACT

A power system is disclosed that includes a fuel cell stack primary power source, a secondary power source, a first direct current bus, a first voltage controlled element that electrically couples power from the secondary power source to the first direct current bus when a voltage across the secondary power source is greater than a voltage across the fuel cell stack primary power source, a second voltage controlled element that electrically couples power from the fuel cell stack primary power source to the first direct current bus when the voltage across the fuel cell stack primary power source is greater than the voltage across the secondary power source, and at least one balance of plant load electrically coupled to the first direct current bus.

### BACKGROUND OF THE INVENTION

1. Field of the Invention

This disclosure generally relates to fuel cell systems suitable for producing electrical power.

2. Description of the Related Art

Electrochemical fuel cells convert fuel and oxidant to electricity. Solid polymer electrochemical fuel cells generally employ a membrane electrode assembly (“MEA”) which includes an ion exchange membrane or solid polymer electrolyte disposed between two electrodes typically comprising a layer of porous, electrically conductive sheet material, such as carbon fiber paper or carbon cloth. The MEA contains a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of fuel cells are electrically coupled in series to form a fuel cell stack supplying a desired power output.

In typical fuel cells, the MEA is disposed between two electrically conductive fluid flow field plates or separator plates. Fluid flow field plates have flow passages to direct fuel and oxidant to the electrodes, namely the anode and the cathode, respectively. The fluid flow field plates act as current collectors, provide support for the electrodes, provide access channels for the fuel and oxidant, and provide channels for the removal of reaction products, such as water formed during fuel cell operation. The fuel cell system may use the reaction products in maintaining the reaction. For example, reaction water may be used for hydrating the ion exchange membrane and/or maintaining the temperature of the fuel cell stack.

During normal operation of a PEM fuel cell stack, fuel is electrochemically reduced on the anode side, typically resulting in the generation of protons, electrons, and possibly other species depending on the fuel employed. The protons are conducted from the reaction sites at which they are generated, through the membrane, to electrochemically react with oxygen in the oxidant on the cathode side. The electrons travel through an external circuit providing useable power and then react with the protons and oxygen on the cathode side to generate electricity.

Conventional fuel cell stacks operate at a relatively high minimum stack and/or cell voltage during normal operating conditions. For example, in some automotive applications, a fuel cell stack provides a nominal output voltage of 240 volts at 300 amps. Individual, serially-connected fuel cells of the fuel cell stack output a nominal voltage per fuel cell during normal operating conditions.

However, during start-up conditions, fuel cell stack start-up voltages are significantly less than the voltages provided from the fuel cell stacks during normal operation. Accordingly, a period of time is required for the start-up process before sufficient voltage and current are available from the fuel cell stack.

Some balance of plant (BOP) devices supporting operation of a fuel cell stack are not designed for operation at the reduced voltages provided by the fuel cells during start-up. An example of a BOP device is an air compressor that provides a nominal rate of air flow to the fuel cells when powered, or sourced, at the nominal voltage range during normal operating conditions. Another example is a coolant pump that circulates a coolant through the fuel cell stack at a nominal rate when powered at the nominal voltage range. A further example of a BOP device is an anode recirculation pump that recirculates a reactant fluid to the fuel cells at a nominal rate when powered at the nominal voltage range.

The above-described BOP devices are used for fuel cell operation, and in particular, for the fuel cell stack start-up process. Accordingly, during the start-up process before sufficient voltage and current are available from the fuel cell stack to supply the load drawn by the BOP devices, the BOP devices are powered from an auxiliary power supply. Examples of auxiliary power supplies include a battery, an ultracapacitor, and/or a relatively small combustion engine. However, such auxiliary power supplies may be limited in their output current and/or energy capacity, thereby limiting the number of BOP devices and/or limiting the time that the BOP devices may be sourced.

Furthermore, during the start-up process before sufficient voltage and current are available from the fuel cell stack to supply the load drawn by the BOP devices, the output voltage of the fuel cell stack may rapidly rise to its open circuit voltage (OCV). Operating a fuel cell stack at its OCV is undesirable because of potential thinning of the fuel cell stack membranes and/or cathode corrosion. Some prior art systems employ bleed resistors to limit voltage of the fuel cell stack.

Typical fuel cell power systems supply the various system and BOP devices via a direct current (DC) bus. The above-described auxiliary power supply is coupled to the DC bus to source the various system and BOP devices. The fuel cell stack is also coupled to the DC bus via a suitable power conversion device, such as linear regulator or a direct current to direct current (DC/DC) converter which is operable to transform power at the DC voltage provided from the fuel cell stack to a voltage of the DC bus.

Contactors may be used to electrically couple and decouple the fuel cell stack from the DC bus to facilitate start-up and shut-down process of the fuel cell stack. However, timing operation of the contactors to coordinate operation of the fuel cell stack, the BOP loads, and the auxiliary power supplies is difficult. Improper coordination of the operation of the contactors may result in the above-described damage to the fuel cell stack. Furthermore, improper coordination of the operation of the contactors may cause other problems, such as back-driving the fuel cell stack.

When the fuel cell stack is providing the power used by its BOP devices, power losses occur in the DC/DC converter (and the attendant transmission wires) because the power must first pass through the DC/DC converter. Accordingly, system efficiency is reduced by such power losses.

Although there have been advances in the field, there remains a need in the art for improving voltage control of the fuel cell stack during the start-up process and for increasing the power efficiency of the fuel cell system. The present disclosure addresses these needs and provides further related advantages.

### BRIEF SUMMARY OF THE INVENTION

In one aspect, a power system comprises a fuel cell stack primary power source, a secondary power source, a first direct current bus, a first voltage controlled element that electrically couples power from the secondary power source to the first direct current bus when a voltage across the secondary power source is greater than a voltage across the fuel cell stack primary power source, a second voltage controlled element that electrically couples power from the fuel cell stack primary power source to the first direct current bus when the voltage across the fuel cell stack primary power source is greater than the voltage across the secondary power source, and at least one balance of plant load electrically coupled to the first direct current bus.

In a further aspect, a power system comprises a power source operable to provide a first amount of power; a fuel cell stack operable to provide a second amount of power at a fuel cell stack voltage; at least one balance of plant (BOP) device operable to receive the first amount of power from the power source and operable to receive the second amount of power from the fuel cell stack; a primary direct current (DC) bus operable to receive at least the first amount of power from the power source and operable at a DC bus voltage; a first voltage controlled element electrically coupled between the primary DC bus and the at least one BOP device, and operable to transfer at least a portion of the first amount of power from the power source to the at least one BOP device when the DC bus voltage is greater than the fuel cell stack voltage; and a second voltage controlled element electrically coupled between the fuel cell stack and the at least one BOP device, and operable to transfer at least a portion of the second amount of power from the fuel cell stack to the at least one BOP device in response to the fuel cell stack voltage being greater than the DC bus voltage.

In a further aspect, a method is disclosed for operating a power system comprising at least one BOP device, a power source electrically coupled to the at least one BOP device and operable to output a first amount of power at a power source voltage, and at least one fuel cell stack electrically coupled to the at least one BOP device and operable to output a second amount of power at a fuel cell stack voltage. The method comprises sourcing a load drawn by the at least one BOP device with the first amount of power in response to the power source voltage being greater than the fuel cell stack voltage, and sourcing the load drawn by the at least one BOP device with the second amount of power in response to the at least one fuel cell stack voltage being greater than the power source voltage.

In a further aspect, the method comprises sourcing a first portion of the load drawn by the at least one BOP device with the first amount of power in response and sourcing a second portion of the load drawn by the at least one BOP device with the second amount of power in response to the fuel cell stack voltage being substantially equal to the power source voltage.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an embodiment of a power system comprising at least one fuel cell stack, a power source, at least one balance of plant (BOP) load, and two voltage controlled elements.

FIG. 2 is a graph plotting fuel stack output power and voltage over time.

FIGS. 3A-3C are schematic diagrams of alternative embodiments of the first and the second voltage controlled elements of FIG. 1.

FIGS. 4A-4C are schematic diagrams of alternative embodiments of the power source of FIG. 1.

FIG. 5 is a schematic diagram illustrating additional components related to the supply of fuel and oxidant to an exemplary embodiment of the power system of claim 1.

FIG. 6 is a flowchart illustrating an embodiment of a process for operating the power system of FIG. 1.

### DETAILED DESCRIPTION

In the following description, certain specific details are set forth in order to provide a thorough understanding of various embodiments. However, one skilled in the relevant art will recognize that the teachings here may be practiced without one or more of these specific details, or with other methods, components, materials, etc. In other instances, well-known structures associated with fuel cell systems including the various operating and control components commonly referred to as balance of plant (BOP) have not been shown or described in detail to avoid unnecessarily obscuring descriptions of the embodiments.

Unless the context requires otherwise, throughout the specification and claims which follow, the word “comprise” and variations thereof, such as “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present fuel cell systems. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

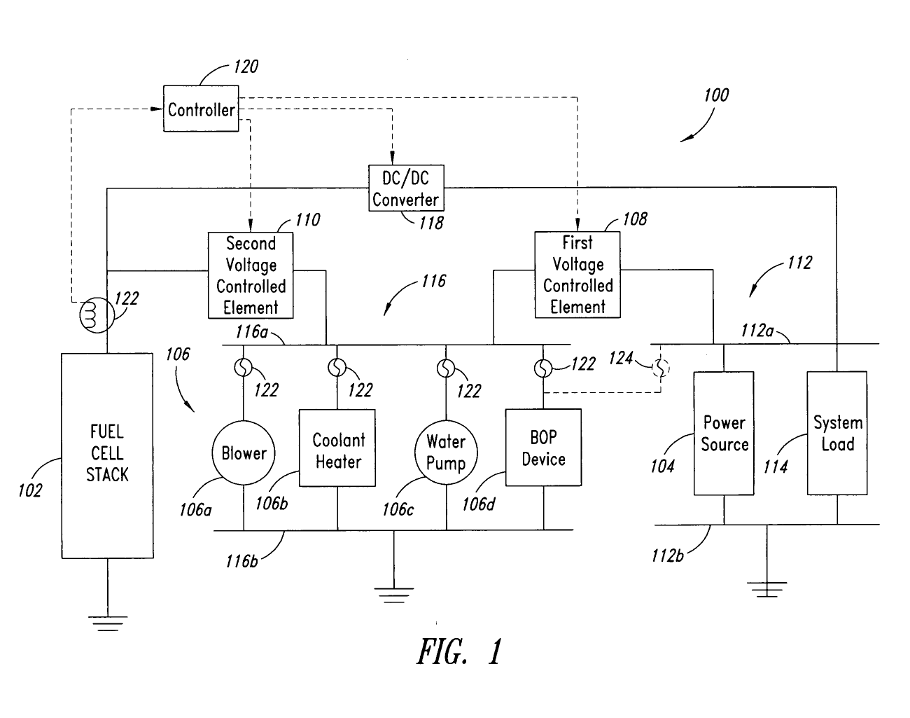

FIG. 1 is a schematic diagram of an embodiment of a power system 100 comprising at least one fuel cell stack 102, a power source 104, at least one balance of plant (BOP) load 106, and two voltage controlled elements 108, 110. The power system 100 is limited to illustrating components relevant to the disclosure of the various embodiments described herein. Other components of the power system 100 are not illustrated or described herein for brevity.

The power source 104 is electrically coupled to a first (or primary) direct current (DC) bus 112 having a positive voltage rail 112a and a negative voltage rail 112b. The DC bus 112 is operable at a first (or primary) DC voltage. A system load 114 is further coupled to the DC bus 112 between the positive voltage rail 112a and the negative voltage rail 112b. System load 114 is representative of a plurality of DC loads sourced by the power system 100. In other embodiments, a direct current to alternating current (AC) conversion device may be used to additionally, or alternatively, source AC loads. Further, DC voltage conversion devices (not shown) may be used to source DC loads coupled to other, different voltage DC busses (not shown).

A plurality of BOP devices 106 are electrically coupled to a second (or secondary) DC bus 116 between a positive voltage rail 116a and a negative voltage rail 116b. The second DC bus 116 is operable at a second (or secondary) DC voltage.

For illustration purposes, the BOP devices 106 include a blower 106a, a coolant heater 106b, a water pump 106c, and a generic BOP device 106d (e.g., a reactant recirculation pump, blower or fan). For convenience, the BOP devices 106a-106d coupled to the second DC bus 116 are collectively referred to as the BOP devices 106. BOP devices 106 are described in greater detail below.

Generally, BOP devices 106 that are coupled to the second DC bus 116 may be characterized as having loads that do not require tight voltage regulation. That is, the BOP devices 106 operate satisfactorily over a range of DC voltage. Preferably, the amount of the load, or power draw, of a BOP device 106 is relatively high. Other BOP devices that may be characterized as requiring relatively tight voltage regulation and/or characterized as a relatively small load are coupled to other suitable sources, such as the first DC bus 112. The nature of the BOP devices 106 coupled to the second DC bus 116 will be described in greater detail below.

The first DC bus 112 is electrically coupled to the second DC bus 116 via a first voltage controlled element 108. The first voltage controlled element 108 is operable to permit the flow of power generated by the power source 104, via the second DC bus 116, to the BOP devices 106. The fuel cell stack 102 is electrically coupled to the second DC bus 116 via a second voltage controlled element 110. The second voltage controlled element 110 is operable to permit the flow of power generated by the fuel cell stack 102 to the second DC bus 116, thereby providing power to the BOP devices 106. Thus, during operating conditions described in greater detail hereinbelow, load drawn by the BOP devices 106 are sourced from the fuel cell stack 102 and/or the power source 104.

During the initial stages of the start-up process of the fuel cell stack 102, the first voltage controlled element 108 permits power to flow from the first DC bus 112 to the second DC bus 116 when the voltage of the fuel cell stack 102 is initially less than the voltage of the second DC bus 116. Also, when the voltage of the fuel cell stack 102 is less than the voltage of the second DC bus 116, the second voltage controlled element 110 prohibits the flow of power from the fuel cell stack 102 to the second DC bus 116. Also, the second voltage controlled element 110 prohibits charging of the fuel cell stack 102 from the first DC bus 112.

During later stages of the start-up process, the second voltage controlled element 110 permits power to flow from the fuel cell stack 102 to the second DC bus 116 when the voltage of the fuel cell stack 102 increases to at least the DC voltage of the second DC bus 116. When the voltage of the second DC bus 116 becomes greater than the voltage of the first DC bus 112, the first voltage controlled element 108 prohibits the flow of power from the first DC bus 112 to the second DC bus 116. Also, the first voltage controlled element 108 prohibits charging of the first DC bus 112 from the second DC bus 116.

Additionally, the fuel cell stack 102 is electrically coupled to the first DC bus 112 via a direct current to direct current (DC/DC) converter 118. The DC/DC converter 118 is operable to transmit power generated by the fuel cell stack 102 to the first DC bus 112 when the amount of power generated by the fuel cell stack 102 exceeds the amount of power sourced to the BOP devices 106. In alternative embodiments, a linear regulator or other suitable power regulating device may replace the DC/DC converter 118. For convenience, such suitable power regulating devices are also referred to as DC/DC converters hereinafter.

Power received from the fuel cell stack 102 is received by the DC/DC converter 118 at the output voltage of the fuel cell stack 102. The DC/DC converter 118 converts the voltage of the power received from fuel cell stack 108 to the voltage of the first DC bus 112. Accordingly, the fuel cell stack 102 may generate power at a different operating voltage than the operating voltage of the first DC bus 112.

Some embodiments of power system 100 optionally include a controller 120. Controller 120 is communicatively coupled to one or more sensors 122 which detect electrical parameters of the fuel cell stack 102. For example, the output voltage, power, and/or current of the fuel cell stack 102 may be sensed. The sensors 122 communicate signals to the controller 120 corresponding to the sensed parameter.

Based upon the sensed parameter, controller 120 may control operation of the second voltage controlled element 110, the first voltage controlled element 108, and/or the DC/DC converter 118. Various operating and control strategies of the controller 120 are described in greater detail below.

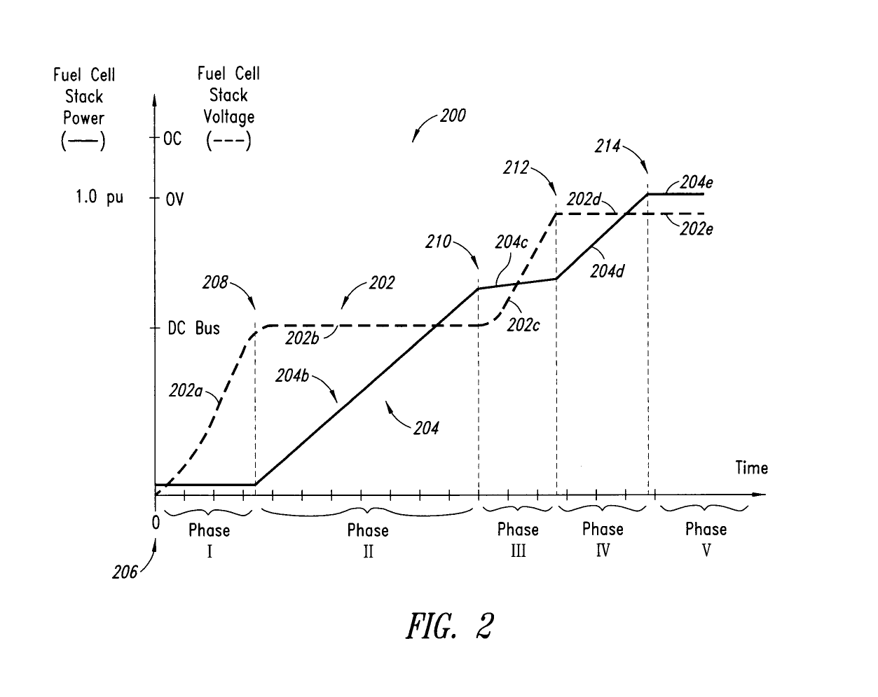

FIG. 2 is a graph 200 plotting fuel stack output power and voltage over time. A voltage curve 202 and a power curve 204 are illustrated on graph 200. The voltage curve 202 corresponds to the output voltage of the fuel cell stack 102. The power curve 204 corresponds to the output DC power (or alternatively to the output DC current) of the fuel cell stack 102.

An initial time 206 on graph 200 corresponds to an operating condition wherein the fuel cell stack 102 (FIG. 1) is shut down (not generating power). Just after the initial time 206, the start-up process of the fuel cell stack 102 begins. For example, the fuel cell stack 102 may be cold started. Or, the fuel cell stack 102 may be idling, and after the initial time 206, fuel may be added to restart the fuel cell stack 102.

As the fuel cell stack 102 is started, the second voltage controlled element 110 prevents power and/or current from flowing out of the fuel cell stack 102 to the second DC bus 116. Concurrently, the DC/DC converter 118 prevents power and/or current from flowing out of the fuel cell stack 102 to the first DC bus 112. Accordingly, the output voltage of the fuel cell stack 102 begins to increase, as generally denoted by the voltage curve portion 202a. This stage of the start-up of the fuel cell stack 102 is referred to and illustrated as Phase I for convenience. The power output of fuel cell stack 102 during Phase I is substantially zero (see the power curve portion 204a).

During Phase I, power from the power source 104 sources the BOP devices 106 via the first voltage controlled element 108. Accordingly, the voltage of the second DC bus 116 is substantially equal to the voltage of the first DC bus 112. Since the second voltage controlled element 110 and the DC/DC converter 118 prevent power flow out of the fuel cell stack 102, the gradually rising output voltage (see the voltage curve portion 202a) of the fuel cell stack 102 does not affect the voltage of the second DC bus 116.

At some point during the start-up process of the fuel cell stack 102, output voltage of the fuel cell stack 102 becomes equal to the voltage of the second DC bus 116, indicated as time 208 on the graph 200. At time 208, the second voltage controlled element 110 electrically couples the fuel cell stack 102 to the second DC bus 116. In alternative embodiments, the second voltage controlled element 110 becomes conductive at time 208. Accordingly, power and/or current from the fuel cell stack 102 is passed to the second DC bus 116. This stage of the start-up of the fuel cell stack 102 is referred to and illustrated as Phase II for convenience.

When the second voltage controlled element 110 permits power and/or current to flow from the fuel cell stack 102 to the second DC bus 116, thereby sourcing the BOP loads 106, the output voltage of the fuel cell stack 102 is controlled by the voltage of the first DC bus 112. Accordingly, the fuel cell stack 102 and the power source 104 are operated at substantially the same DC voltage.

Since the output voltage of the fuel cell stack 102 is fixed to substantially equal the voltage of the second DC bus 116, a gradually increasing amount of power may be drawn from the fuel cell stack 102 to source a portion of the power consumed by the BOP devices 106. That is, as the reaction process in the fuel cell stack 102 increases, and given that the output voltage of the fuel cell stack 102 is fixed, power and/or current output of the fuel cell stack 102 increases.

This phase of the start-up process, where voltage of the fuel cell stack 102 substantially equals the voltage of the second DC bus 116, and where power output from the fuel cell stack 102 gradually increases, is referred to and illustrated in FIG. 2 as Phase II. Accordingly, the voltage curve portion 202b of the voltage curve 202 illustrates a fixed output voltage of the fuel cell stack 102. The power curve portion 204b illustrates the gradually increasing power and/or current supplied by the fuel cell stack 102 to the BOP devices 106 via the second voltage controlled element 110.

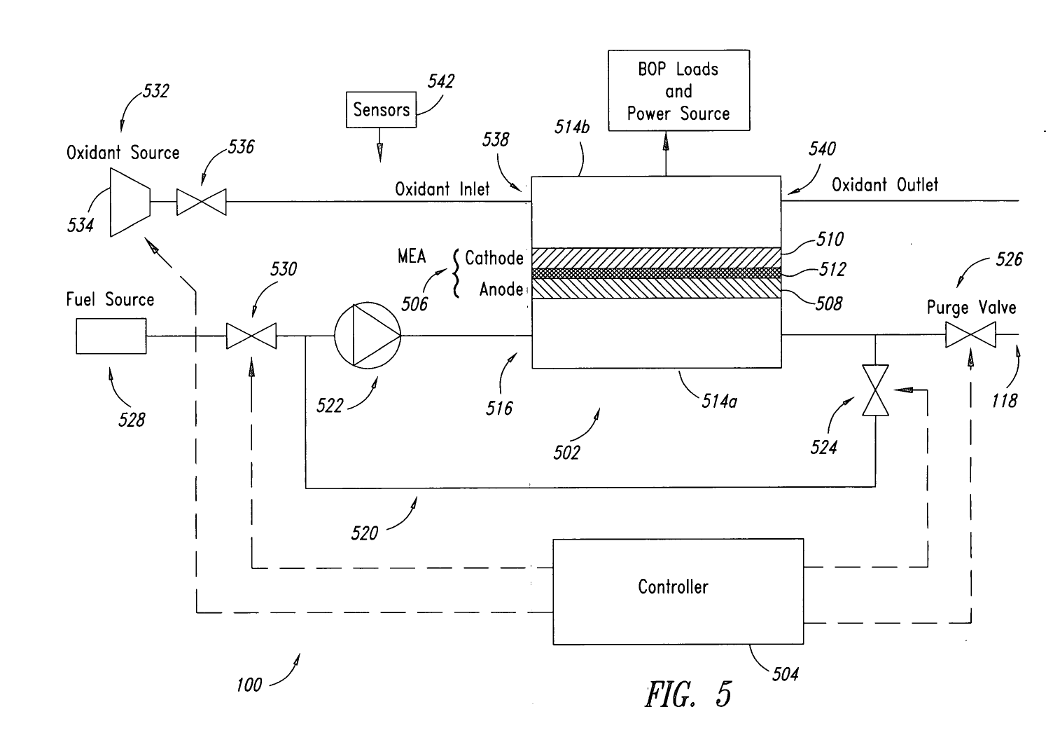

During Phase II, a portion of the power and/or current consumed by the BOP devices 106 is sourced from the fuel cell stack 102, and the remaining portion of the power and/or current consumed by the BOP devices 106 is sourced from the power source 104. The load of the BOP devices 106 on the fuel cell stack 102 helps to minimize corrosion of the fuel cell cathode 510 (FIG. 5) and prevents the fuel cell stack 102 from rising to its open circuit voltage (OCV). As Phase II proceeds, the amount of power sourced to the BOP devices 106 from the fuel cell stack 102 increases and the amount sourced from the power supply 104 decreases.

At some point during the start-up process illustrated in FIG. 2, the amount of power and/or current drawn by the BOP devices 106 will be entirely sourced from the fuel cell stack 102, which is illustrated for convenience as time 210. At time 210, voltage of the fuel cell stack 102 increases as the electrical generation process proceeds because additional power or current is not drawn from the fuel cell stack 102. In response to the voltage of fuel cell stack 102 increasing above voltage of the first DC bus 112, the first voltage controlled element 108 blocks or otherwise prevents power from flowing from the second DC bus 116 to the first DC bus 112.

At time 210, the start-up process enters into Phase III. During Phase III, output voltage of the fuel cell stack 102 controls the voltage of the second DC bus 116. Phase III is generally characterized by a substantially constant power and/or current output from the fuel cell stack 102, as illustrated by the power curve portion 204c, and by a gradually increasing output voltage of the fuel cell stack 102, as illustrated by the voltage curve portion 202c.

Power drawn by the BOP devices 106 may slightly increase during Phase III since a portion of the load of the BOP devices 106 is resistive. Power consumed by a resistive load increases with increasing voltage.

At some point in time, which is illustrated for convenience as time 212, output voltage of the fuel cell stack 102 reaches a desired operating voltage (OV). This desired operating voltage of the fuel cell stack 102 may be a voltage at which the fuel cell stack 102 efficiently operates. Accordingly, the start-up process enters into Phase IV.

For convenience, the output voltage of the fuel cell stack 102 during Phase IV is indicated as being substantially constant, as illustrated by the voltage curve portion 202d. In practice, the desired operating voltage of the fuel cell stack 102 may be any suitable operating voltage based on a selected criteria, and may even vary during Phase IV. During Phase IV, the voltage curve portion 202d remains higher than the voltage curve portion 202d (which corresponds to the voltage of the first DC bus 112).

During Phase IV, the increasing power and/or current output from the fuel cell stack 102 is transferred to the first DC bus 112 via the DC/DC converter 118. It is appreciated that the power transferred to the first DC bus 112 via the DC/DC converter 118 is approximately equal to the difference between the power drawn by the BOP devices 106 and the power generated by the fuel cell stack 102. It is further appreciated that because the DC/DC converter 118 is controlled by the controller 120, output voltage of the fuel cell stack 102 may be controllable by selectively controlling the operation of the DC/DC converter 118.

Further, the load drawn by the BOP devices 106 may change during Phase IV. The controller 120 operates the DC/DC converter 118 in response to the change in power drawn by the BOP devices to transfer a corresponding amount of power from the fuel cell stack 102 to the first DC bus 112, via the DC/DC converter 118.

Power and/or current output from the fuel cell stack 102 increases during Phase IV up to the normal operating power and/or current output of the fuel cell stack 102, which is generally indicated at time 214. At time 214, the start-up process has been completed. That is, the fuel cell stack 102 is being operated at its designed and/or intended operating conditions, generally denoted as Phase V in FIG. 2. For convenience, the output voltage of the fuel cell stack 102 is illustrated as being constant (voltage curve portion 202e). Also for convenience, the output power of the fuel cell stack 102 is illustrated as being constant (power curve portion 204e). It is appreciated that during Phase V the fuel cell stack 102 may be operated at any suitable output voltage and/or at any suitable output power at which the fuel cell stack 102 is designed to operate.

The above-described operation of the power system 100 may vary from the hypothetical exemplary process illustrated in Phases I-V of FIG. 2, depending upon the nature of the fuel cell stack 102. For example, the gradually increasing output voltage of the fuel cell stack 102 during Phase I may not necessarily appear as illustrated in FIG. 2. In some situations, the voltage may change at a higher rate or a lower rate, or may even change in a non-linear manner. The voltage curve 202a during Phase I is intended to generally illustrate a portion of a hypothetical start-up of any suitable fuel cell stack 102 as used in an embodiment of the power system 100. Furthermore, the relative length of the time period of the Phase I may be longer or shorter than illustrated in FIG. 2.

Similarly, the illustrated voltage curve portions 202b-202e, and the illustrated power curve portions 204a-204e, may vary from the simplified hypothetical example of FIG. 2. Accordingly, the illustrated changes in the output voltage and power of the fuel cell stack 102 during Phases I-V are intended to generally illustrate operation of a hypothetical embodiment of the power system 100.

Embodiments of the power system 100 also facilitate shut down of an operating fuel cell stack 102 (FIG. 1). The shut-down process, in one embodiment, is initiated by first halting a flow of oxidant to the fuel cell stack 102. As the reaction process within the fuel cell stack 102 consumes the oxidant, the reaction process slows. Accordingly, power output from the fuel cell stack 102 decreases. Output voltage of the fuel cell stack 102 may be held relatively constant or may be controllably varied during this phase of the shut-down process through operation of the DC/DC converter 118. During this phase, power drawn by the BOP devices 106 is supplied from the fuel cell stack 102, and power in excess of the amount of power drawn by the BOP devices 106 is transferred to the first DC bus 112 via the DC/DC converter 118. This phase of the shut-down process generally corresponds to the reverse of Phase IV illustrated in FIG. 2.

At some point, the decreasing power output from the fuel cell stack 106 just equals the power drawn by the BOP devices 106. Accordingly, the DC/DC converter 118 is operated so that no power flows from the fuel cell stack 102 to the first DC bus 112.

After that point in the shut-down process, output voltage of the fuel cell stack 102 decreases. Accordingly, voltage of the second DC bus 116, which is controlled by the output voltage of the fuel cell stack 102, also decreases. This phase of the shut-down process generally corresponds to the reverse of Phase III illustrated in FIG. 2.

At some point, the voltage of the second DC bus 116 (and the output voltage of the fuel cell stack 102) decreases to a value that is substantially equal to the voltage of the first DC bus 112. Then, the first voltage controlled element 108 electrically couples the first DC bus 112 and the second DC bus 116. Accordingly, the voltage of the first DC bus 112 and the second DC bus 116 are substantially equal. Furthermore, the output voltage of the fuel cell stack 102 is held at substantially the same voltage as the second DC bus 116, which is now regulated by the output voltage of the power source 104.

Power output from the fuel cell stack 102 continues to decrease. Since the BOP devices 106 continue to draw power, the change in power supplied from the fuel cell stack 102 is offset by power from the power source 104. This phase of the shut-down process generally corresponds to the reverse of Phase II illustrated in FIG. 2. The load of the BOP devices 106 on the fuel cell stack 102 during shutdown helps to minimize corrosion of the fuel cell cathode 510 (FIG. 5) and prevents the fuel cell stack 102 from rising to its OCV. As the load of the BOP devices 106 shift back to the power source 104 from the fuel cell stack 102, there will be less chance of driving any particular fuel cell in the fuel cell stack 102 into cell reversal or of fuel staving any particular fuel cell of the fuel cell stack 102 of fuel.

Finally, the output power of the fuel cell stack 102 is substantially zero. The decay of the voltage within the fuel cell stack 102 to zero concludes the shut-down process.

As noted above, the BOP devices 106 coupled to the second DC bus 116 may be characterized as having power draws that do not require tight voltage regulation. That is, the loads on the second DC bus 116 operate satisfactorily over a relatively wide range of DC voltage. Accordingly, during the above-illustrated operating Phases I-IV (FIG. 2), the BOP devices 106 operate satisfactorily at any DC voltage between the operating voltage of the first DC bus 112 (Phases I and II) and the output voltage of the fuel cell stack 102 (Phases III-IV).

For example, the illustrated blower 106a and/or water pump 106c, which are operable to transport a fluid to the fuel cell stack 102, may be comprised of DC motors that are operable at variable DC voltages. At lower DC voltages, such as when sourced at the voltage of the first DC bus 112 during Phases I and II illustrated in FIG. 2, blower 106a and/or water pump 106c may provide sufficient fluid flow to the fuel cell stack 102 to accommodate the initial phases of the start-up process. As voltage supplied to the BOP devices 106 increases, such as during Phase III illustrated in FIG. 2, output of the blower 106a and/or water pump 106c (resulting from the increasing voltage) may increase fluid flows to accommodate the higher power output operation of the fuel cell stack 102.

For convenience, four BOP devices 106 were illustrated as coupled to the second DC bus 116. It is appreciated that any suitable number of BOP devices 106 may be coupled to the second DC bus 116, including a single BOP device 106. Furthermore, BOP devices 106 that draw relatively small amounts of power may be optionally coupled to the second DC power bus 116 for convenience.

Generally, BOP devices 106 are understood to be balance of plant type loads associated with operation of a fuel cell stack 102 or the power system 100. In alternative embodiments, other types of load devices may also be coupled to the second DC bus 116. For example, if the power system 100 resides in a vehicle, a passenger compartment heater may be coupled to the second DC bus 116.

In some embodiments, a plurality of BOP devices 106 are coupleable to the second DC bus 116 via an optional contactor, switch, or suitable connecting device 122. Some embodiments may provide another contactor, switch, or suitable connecting device 124 so that the BOP device 106 may be alternatively coupled to the first DC bus 112.

Further, not all BOP devices must be coupled to the second DC bus 116. Other BOP devices (not shown), such as those that draw a relatively small load or that are preferably regulated at a desired voltage, may be coupled to the first DC bus 112 or to another suitable power source.

Furthermore, by coupling BOP devices 106 to the second DC bus 116, overall system losses may be reduced and operating efficiency increased. For example, the illustrated blower 106a may be a component of air compressor 534 (FIG. 5). Blower 106a may consume between 10% to 20% of the gross output power from the fuel cell stack 102. By coupling the blower 106a directly to the second DC bus 116, power can be supplied directly from the output of the fuel cell stack 102. Accordingly, losses are reduced in the DC/DC converter 118 (and the attendant transmission wires) since the power drawn by the blower 106a does not need to be transmitted to the first DC bus 112 via the DC/DC converter 118. Additionally, since the BOP devices 106 do not need to be sourced via power transferred through the DC/DC converter 118, the size of the DC/DC converter 118 (and its associated cost) may be reduced.

As noted above, during Phases I and II (FIG. 2), the output voltage of the fuel cell stack 102 is held to a value that is not greater than the operating voltage of the first DC bus 112. During phases III-V, the output voltage of the fuel cell stack 102 is held to a value that is equal to or less than the intended operating voltage of the fuel cell stack 102. Accordingly, output voltage of the fuel cell stack 102 does not increase to the OCV of the fuel cell stack 102, thereby avoiding membrane thinning and/or cathode corrosion associated with operating a fuel cell stack 102 at its OCV.

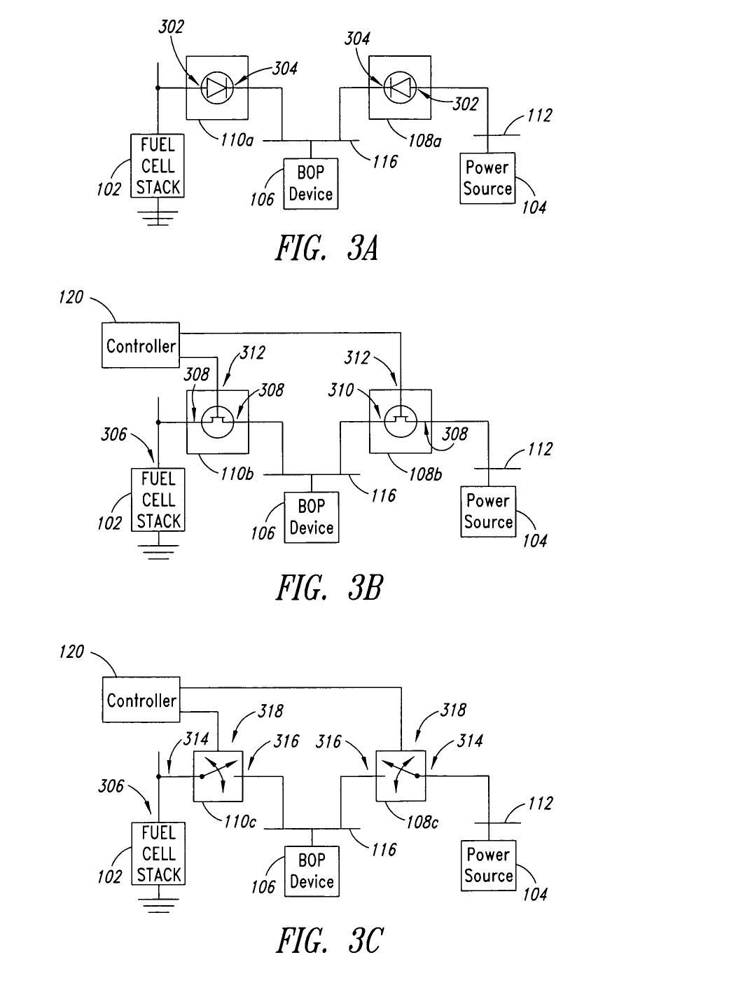

FIGS. 3A-3C are schematic diagrams of alternative embodiments of the first voltage controlled element 108 and the second voltage controlled element 110. Any suitable voltage controlled element 108, 110 may be used in alternative embodiments.

FIG. 3A illustrates an embodiment where the first voltage controlled element 108 and the second voltage controlled element 110 comprise diodes 108a and 110a, respectively. Each diode 108a, 110a comprises an anode 302 and a cathode 304. The anode 302 of the diode 108a is coupled to the positive terminal 306 of the fuel cell stack 102. The cathode 304 of the diode 108a is coupled to the BOP device 106 via the second DC bus 116. Similarly, the anode 302 of the diode 110a is coupled to the first DC bus 112 and the cathode 304 of the diode 108a is coupled to the BOP device 106 via the second DC bus 116.

The diode 108a forward biases to conduct current (and hence power) from the power source 104 to the second DC bus 116 when the voltage of the first DC bus 112 is substantially equal to the voltage of the second DC bus 116. The diode 110a forward biases to conduct current (and hence power) from the fuel cell stack 102 to the second DC bus 116 when the output voltage of the fuel cell stack 102 is substantially equal to the voltage of the second DC bus 116. In alternative embodiments, other solid state conducting devices may be used for the first voltage controlled element 108 and the second voltage controlled element 110.

FIG. 3B illustrates an embodiment where the first voltage controlled element 108 and the second voltage controlled element 110 comprise controllable conducting devices 108b and 110b, respectively. Each controllable conducting device 108b, 110b comprises an drain 308, a source 310, and a gate 312. The drain 308 of the controllable conducting device 108b is coupled to the positive terminal 310 of the fuel cell stack 102. The source 310 of the controllable conducting device 108b is coupled to the BOP device 106 via the second DC bus 116. Similarly, the drain 308 of the controllable conducting device 110b is coupled to the first DC bus 112 and the source 310 of the controllable conducting device 108b is coupled to the BOP device 106 via the second DC bus 116.

The gate 312 is coupled to the controller 120. Control signals received from the controller 120 at the gate 312 cause the controllable conducting devices 108b, 110b to become conductive or non-conductive, as described in greater detail below.

The controllable conducting device 108b forward biases to conduct current (and hence power) from the power source 104 to the second DC bus 116 when a gating control signal is received from controller 120. Controller 120 communicates the gating control signal to the controllable conducting device 108b when the voltage of the first DC bus 112 is greater than (Phase I, see FIG. 2) or substantially equal to (Phase II) the voltage of the second DC bus 116.

The controllable conducting device 110b forward biases to conduct current (and hence power) from the fuel cell stack 102 to the second DC bus 116 when a gating control signal is received from controller 120. Controller 120 communicates the gating control to the controllable conducting device 110b when the output voltage of the fuel cell stack 102 increases to be substantially equal to (Phase II) the voltage of the second DC bus 116. The gating control signal to the controllable conducting device 110b is then maintained (Phases III-V).

Similarly, the controllable conducting device 108b is blocked to prohibit current flow (and hence power) from the power source 104 to the second DC bus 116 when the gating control signal is removed by controller 120. Controller 120 removes the gating control signal to the controllable conducting device 108b when the voltage of the first DC bus 112 is less than (Phases III-V) the voltage of the second DC bus 116.

The controllable conducting device 110b is blocked to prohibit current flow (and hence power) from the fuel cell stack 102 to the second DC bus 116 when gating control signal is removed by controller 120. Controller 120 removes the gating control signal to the controllable conducting device 110b when the output voltage of the fuel cell stack 102 is less than (Phase I) the voltage of the second DC bus 116.

In the various embodiments, any suitable controllable solid state conducting device may be used for the first voltage controlled element 108 and the second voltage controlled element 110. Non-limiting examples of the controllable conducting devices 108b and 110b are suitable field effect transistors (FETs) or insulated gate bipolar transistors (IGBTs).

FIG. 3C illustrates an embodiment where the first voltage controlled element 108 and the second voltage controlled element 110 comprise a controllable switch 108c and 110c, respectively. Each controllable switch 108a, 110a comprises a first terminal 314, a second terminal 316, and a third terminal 318.

The first terminal 314 of the controllable switch 110c is coupled to the positive terminal 306 of the fuel cell stack 102. The second terminal 316 of the controllable switch 108c is coupled to the BOP device 106 via the second DC bus 116. The third terminal 318 of the controllable switch 108c is coupled to the controller 120. Similarly, with respect to the controllable switch 110c, the first terminal 314 is coupled to the first DC bus 112, the second terminal 316 is coupled to the BOP device 106 via the second DC bus 116, and the third terminal 318 is coupled to the controller 120.

The controllable switch 108c is closed to conduct current (and hence power) from the power source 104 to the second DC bus 116 when a control signal is received from controller 120. Controller 120 communicates a signal to the third terminal 318 of the controllable conducting device 108c when the voltage of the first DC bus 112 is greater than (Phase I) or substantially equal to (Phase II) the voltage of the second DC bus 116.

The controllable conducting device 110c closes to conduct current flow (and hence power) from the fuel cell stack 102 to the second DC bus 116 when a control signal is received from controller 120. Controller 120 communicates the signal to the third terminal 318 of the controllable conducting device 110c when the output voltage of the fuel cell stack 102 is substantially equal to (Phase II) or greater than (Phases III-V) the voltage of the second DC bus 116.

Similarly, the controllable switch 108c is opened to prohibit current flow (and hence power) from the power source 104 to the second DC bus 116 when a control signal to open the switch 108c is received from controller 120. Controller 120 communicates the open switch control signal to the controllable conducting device 108c when the voltage of the first DC bus 112 is at least less than (Phases III-V) the voltage of the second DC bus 116.

The controllable conducting device 110c is opened to prohibit current flow (and hence power) from the fuel cell stack 102 to the second DC bus 116 when a control signal is received from controller 120. Controller 120 communicates an open switch signal to the controllable conducting device 110c when the output voltage of the fuel cell stack 102 is substantially less than (Phase I) the voltage of the second DC bus 116.

In the various embodiments, any suitable controllable solid state conducting devices may be used for the first voltage controlled element 108 and the second voltage controlled element 110. Non-limiting examples of the controllable conducting devices 108c and 110c are suitable electromechanical switches or electric switches.

The various alternative embodiments of the first voltage controlled element 108 and the second voltage controlled element 110 described above and illustrated in FIGS. 3A-3C are not exhaustive. Further, the first voltage controlled element 108 and the second voltage controlled element 110 need not be the same device. For example, the first voltage controlled element 108 may comprise a diode 108a (FIG. 3A) and the second voltage controlled element 110 may comprise a controllable conducting device 110b (FIG. 3B). Any combination of different types of the first voltage controlled element 108 and the second voltage controlled element 110 in alternative embodiments of the power system 100 is possible.

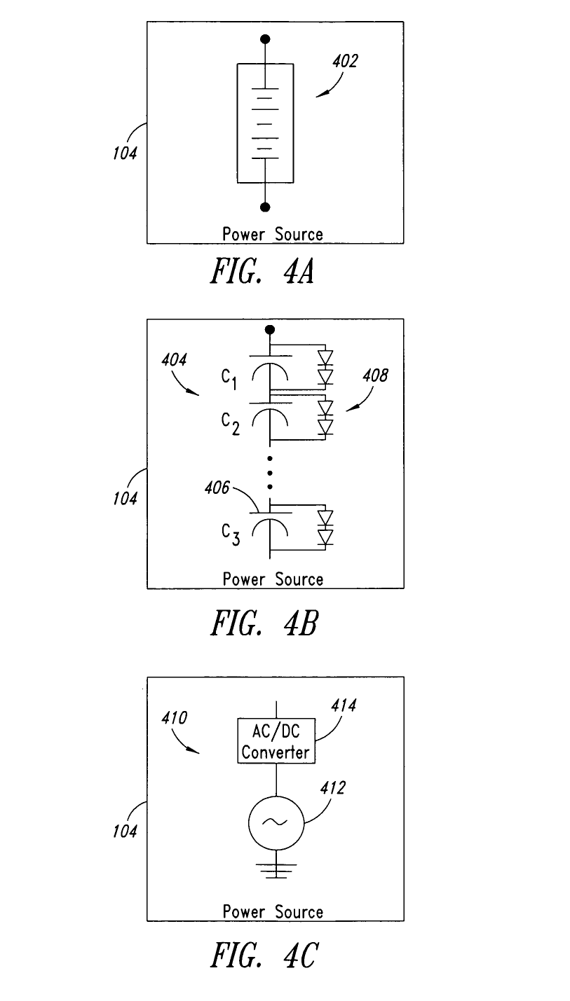

FIGS. 4A-4C are schematic diagrams of alternative embodiments of the power source 104 (FIG. 1). FIG. 4A illustrates a first embodiment of the power source 104 comprising a battery, a plurality of batteries, or a plurality of battery cells (generally denoted with reference numeral 402). Any type of suitable battery may be used, for example, a rechargeable battery.

FIG. 4B illustrates a second embodiment of the power source 104 comprising a super capacitor, an ultracapacitor, a plurality of super capacitors or ultracapacitors, or super capacitor or ultracapacitor cells (generally denoted with reference numeral 404). The super capacitors 404 may be coupled to other devices, such as the exemplary diodes 408. Any type of suitable capacitor 406 may be used.

FIG. 4C illustrates a third embodiment of the power source 104 comprising an alternating current (AC) system 410. The AC system 410 comprises an AC power source 412 and an alternating current to direct current (AC/DC) converter 416. The AC power source 412 may be any suitable AC machine that is operable in a power generation mode. For example, the AC power source 412 may be mechanically coupled to a fossil fuel burning engine or the like. As another example, the AC power source 412 may be coupled to a wheel or axle of a vehicle and used to propel the vehicle when operated as a motor, and used as a brake to slow or stop the vehicle. When operated as a brake, the AC power source 412 may operate as a generator that converts the kinetic energy of the slowing or stopping vehicle into electrical power. Any type of suitable AC power source 412 may be used.

The AC/DC converter 414 converts AC power received from the AC power source 412 into DC power. The DC power is then transferred onto the first DC bus 112 (FIG. 1). In the various embodiments, any suitable type of AC/DC converter 414 may be used

Other benefits are realized from the various embodiments of the power system 100. For example, by coupling the BOP devices 106 to the second DC bus 116, and shifting the loads to the power source 104 when the voltage of the first DC bus 112 is greater than the operating voltage of the fuel cell stack 102, the possibility of the fuel cell stack 102 operating in a reverse mode is reduced. Also, the possibility of fuel starving the fuel cell stack 102 is reduced.

As noted above, the various embodiments facilitate start-up and shut-down processes of the fuel cell stack 102. The start-up and shut-down processes of the fuel cell stack 102 were described above in terms of the output voltage and output power of the fuel cell stack 102. An exemplary start-up and shut-down process of the fuel cell stack 102 are described below in terms of the control of fuel and oxidant to the fuel cell stack 102 with respect to an exemplary fuel and oxidant system of an fuel cell stack 102.

FIG. 5 is a schematic diagram illustrating additional components related to the supply of fuel and oxidant to an exemplary embodiment of a power system 100. Power system 100 illustrates an exemplary fuel cell 502 (of a fuel cell stack 102) and a controller 504. Controller 504 and the above-described controller 104 (FIG. 1) may be implemented as the same device or as separate devices.

Fuel cell 502 includes at least one membrane electrode assembly (MEA) 506 including two electrodes, the anode 508 and the cathode 510, separated by an ion exchange membrane 512. Fuel cell 502 also comprises a pair of flow field plates 514a, 514b. In the illustrated embodiment, the flow field plate 514a includes one or more reactant channels (not shown) formed on a planar surface of flow field plate 514a for carrying fuel to anode 508. The flow field plate 514b includes one or more oxidant channels (not shown) formed on a planar surface of flow field plate 514b for carrying oxidant to cathode 510. In some embodiments, oxidant channels that carry the oxidant also carry exhaust air and product water away from cathode 510.

Fuel cell 502 includes a fuel stream inlet port 516 for introducing a supply fuel stream into fuel cell 502 and a fuel stream outlet port 518 for discharging an exhaust fuel stream from fuel cell 502. The exhaust fuel stream comprises primarily water, non-reactive components, impurities, and some amounts of residual fuel. For convenience, the fuel stream inlet port 516 may also be referred to as an anode inlet, a reactant inlet or the like. The supply and exhaust fuel streams may be collectively referred to as a reactant fuel stream for convenience.

In some embodiments, the power system 100 may have a recirculation system 520 designed to recirculate the fuel exhaust stream from the fuel cell 502 back to the fuel inlet 516. A pump 522 recirculates fuel to the fuel cells 502 of the fuel cell stack 102 at a desired flow rate. Pump 522 may be a suitable BOP device 106 (FIG. 1) to be sourced from the second DC bus 116 as described above. Optionally, a recirculation valve 524 may be included to control flow through the recirculation system 520. When a plurality of fuel cells 502 are serially coupled in a fuel cell stack 102, the recirculation system 520 may be fluidly coupled to all of the fuel cells 502 and would be operable to recirculate and/or source fuel to all of the fuel cells 502.

Although fuel cell 502 is designed to consume substantially all of the fuel supplied to it during operation, traces of unreacted fuel may also be discharged through the fuel stream outlet port 518 during a purge of fuel cell stack 102, effected by temporarily opening a purge valve 526 at the fuel stream outlet port 518. When a plurality of fuel cells 502 are serially coupled in a fuel cell stack 102, the purge valve 526 may be fluidly coupled to all of the fuel cells 502 and would be operable to discharge unreacted fuel from all of the fuel cells 502. For convenience, the fuel stream outlet port 518 may also be referred to as a reactant outlet or the like.

In one embodiment, each membrane electrode assembly 506 is designed to produce a nominal potential between the anode 508 and the cathode 510. Accordingly, a plurality of individual membrane electrode assemblies 506 and their associated flow field plates 514a, 514b may be electrically operated in series in a fuel cell stack 102 to produce current at a desired voltage.

Fuel source system 528 provides fuel (e.g., hydrogen) to the anode 508 by way of fuel source system 528. For example, the fuel source system 528 may include a source of fuel such as one or more fuel tanks (not shown) and a fuel regulating system (not shown) for controlling delivery of the fuel. Fuel source system 528 may be coupled to a main gas valve 530. Valve 530 is automatically controlled by controller 504 for controlling the flow of fuel introduction into the flow field plate 514a. Accordingly, main gas valve 530 opens and closes in response to signals from controller 504. In one embodiment, the controller 504 throttles the main gas valve 530 to at least reduce a rate at which the new reactant is added to the reactant fluid stream. When a plurality of fuel cells 502 are serially coupled in a fuel cell stack 102, the main gas valve 530 may be fluidly coupled to all of the fuel cells 502 and would be operable to provide fuel to all of the fuel cells 502.

The purge valve 526 is provided at the fuel stream outlet port 518 of fuel cell stack 102 and is typically in a closed position when fuel cell stack 102 is operating. Fuel is thus supplied to fuel cell stack 102 only as needed to sustain the desired rate of electrochemical reaction. In one embodiment, nitrogen (and other impurities) may begin to contaminate the fuel stream as described above. When the presence of these impurities leads to a degraded performance of the fuel cell, the controller 504 or another suitable control system sends a signal to the purge valve 526 to open so as to allow discharge of the impurities and other non reactive components that may have collected in the fuel stream. The venting of fuel during a purge is appropriately limited to a short period of time to limit the loss of useful fuel, as such losses lower the efficiency of the fuel cell system.

Power system 100 provides oxidant an oxidant stream to the cathode side of membrane electrode assemblies 506 by way of an oxidant supply system 532. A source of oxygen or air to the oxidant supply system 532 can take the form of an air tank or the ambient atmosphere. An air compressor 534 provides the oxidant to fuel cell stack 102, via the oxidant inlet 538, at a desired flow rate. As noted above, air compressor 534 may use a blower that is a suitable BOP device 106 (FIG. 1) to be sourced from the second DC bus 116. Optionally, an oxidant supply valve 536 may also be included. The oxidant exits the fuel cell stack 102 via the oxidant outlet 540. When a plurality of fuel cells 502 are serially coupled in a fuel cell stack 102, the oxidant supply system 532, air compressor 534, and oxidant supply valve 536 may be fluidly coupled to all of the fuel cells 502 and would be operable to provide air or oxidant to all of the fuel cells 502.

In some embodiments, an optional humidity exchanger (not shown) may add water vapor to the oxidant to keep the ion exchange membrane 512 moist. The optional humidity exchanger (not shown) may also remove water vapor which is a byproduct of the electrochemical reaction.

Controller 104 includes sensors 542 for monitoring power system 100 surroundings and actuators (not shown) for controlling power system 100 accordingly. Sensors 542 may correspond to some of the above-described sensors 142. During operation, controller 504 receives the various sensor measurements such as, but not limited to, ambient air temperature, fuel pressure, fuel concentration, oxygen concentration, fuel cell stack current, air mass flow, cell voltage check status, voltage across the fuel cell stack 102. Controller 504 provides the control signals to the various valves to control operation of the power system 100.

As noted above, electrical power is output from the power system 100 to one or more BOP devices 106 (FIG. 1) loads, system loads 114, and/or power source. The above-described embodiment of power system 100, including the fuel cell stacks 102 and the controller 504, generally describe an exemplary embodiment. Other embodiments of a power system 100 may include other components and/or systems not described in detail herein for brevity. Such various types of fuel cell systems 100 are too numerous to conveniently be described herein, and are omitted for brevity. However, all such embodiment power systems 100 are intended to be included within the scope of this disclosure.

Start-up of the exemplary fuel cell stack 102 is initiated by starting flow of the fuel to the fuel cell stack 102. For example, the main valve 530 would be opened and the blower 522 operated, thereby providing a flow of fuel into the anode 508. At some point, an oxidant is provided to the anode 508. For example, the oxidant supply valve 536 would be opened and the compressor 534 operated, thereby providing a flow of oxidant (or air) into the cathode 510. As the supply of oxidant in the cathode 510 and the fuel in the anode 508 is consumed by the electricity producing reaction process, power, voltage and/or current supplied from the fuel cell stack 102 will increase as described above.

Shut-down of the exemplary fuel cell stack 102 is initiated by halting flow of the oxidant to the fuel cell stack 102. For example, the oxidant supply valve 536 would be closed (shut off), thereby halting flow of oxidant (or air) into the cathode 510. As the supply of existing oxidant in the cathode 510 is consumed (depleted) by the electricity producing reaction process, power supplied from the fuel cell stack 102 will decrease as described above. Accordingly, power (and current) will decay in response to depletion of the oxidant. At some point in the oxidant depletion process, the fuel cell stack 102 will no longer be able to maintain its voltage. Eventually the shut-down process is completed.

At some point in the shut-down process, flow of fuel into the fuel cell stack 102 may be halted. For example, the main gas valve 530 would be closed (shut off), thereby halting flow of fuel into the anode 508.

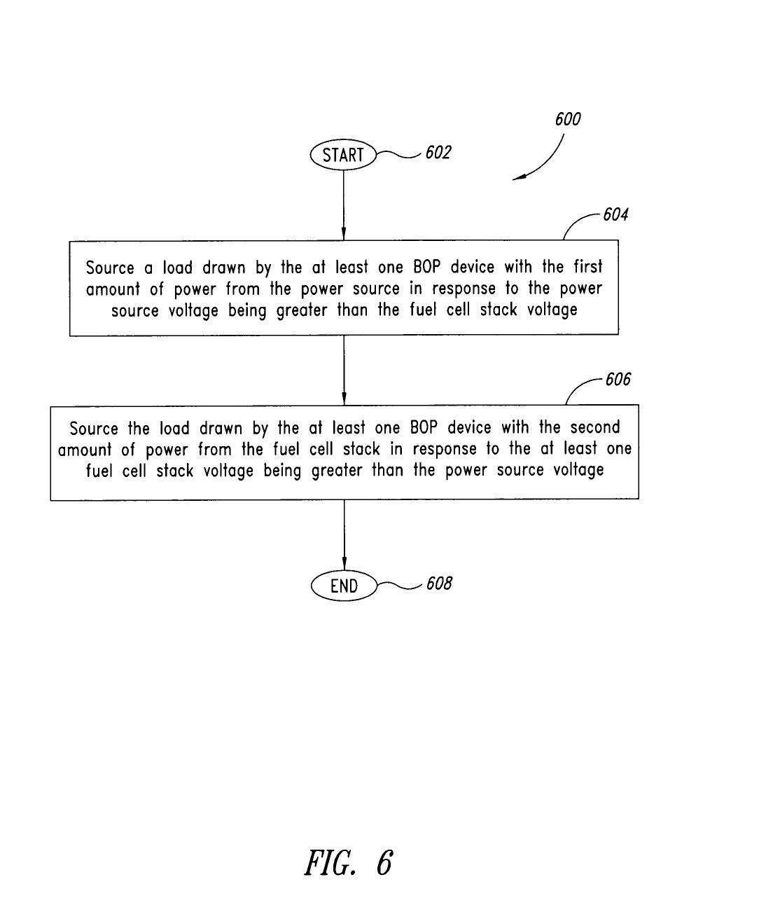

FIG. 6 is a flow chart 600 illustrating an embodiment of a process for operating the power system 100 (FIG. 1). It should be noted that in some alternative implementations, the functions noted in the blocks may occur out of the order noted in FIG. 6, may include additional functions, and/or may omit some functions. For example, two blocks shown in succession in FIG. 6 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process starts at block 602. A load drawn by the at least one BOP device 106 is sourced with the first amount of power from the power source 104 in response to the power source voltage being greater than the fuel cell stack voltage at block 604. The load drawn by the at least one BOP device 106 is sourced with the second amount of power from the fuel cell stack 102 in response to the at least one fuel cell stack voltage being greater than the power source voltage at block 606. The process ends at block 608.

As noted above, when the voltage of fuel cell stack 102 (FIG. 1) substantially equals the voltage of the power source 104, a first portion of the load drawn by the at least one BOP device 106 is sourced with the first amount of power a second portion of the load drawn by the at least one BOP device 106 is sourced with the second amount of power in response to the fuel cell stack voltage being substantially equal to the power source voltage. At least a portion of the system load 114 is sourced with a portion of the second amount of power via the DC/DC converter 118 coupled to the at least one fuel cell stack 102 in response to the second amount of power exceeding the load drawn by the BOP device(s) 106.

In the various embodiments, any suitable type of fuel cell stack 102 may be used. The possible forms of suitable fuel cell stacks 102 are too numerous to be conveniently described herein. For example, different types of fuel cell stacks 102 use different types of reactants and oxidants. One example of different oxidant types includes air and substantially pure oxygen. Some types of fuel cell stacks 102 operate in a dead-ended mode and other types of fuel cell stacks 102 operate using a recirculating reactant system (not shown). It is intended that all such fuel cell stack embodiments are included within the scope of this disclosure.

Similarly, in the various embodiments, any suitable type of DC/DC converter 118 may be used. The possible forms of suitable DC/DC converters 118 are too numerous to be conveniently described herein. It is intended that all such DC/DC converter embodiments are included within the scope of this disclosure.

The various embodiments described above can be combined to provide further embodiments. All of the above U.S. patents, patent applications and publications referred to in this specification, including but not limited to: copending utility application entitled, “POWER SYSTEM METHOD AND APPARATUS,” having Ser. No. 11/255,162, filed Oct. 20, 2005; U.S. Pat. No. 6,603,672 entitled “POWER CONVERTER SYSTEM,” issued Aug. 5, 2005; U.S. patent application Ser. No. 10/430,903, filed May 6, 2003, entitled “METHOD AND APPARATUS FOR IMPROVING THE PERFORMANCE OF A FUEL CELL ELECTRIC POWER SYSTEM”; U.S. patent application Ser. No. 10/440,034, filed May 16, 2003, entitled “ADJUSTABLE ARRAY OF FUEL CELL SYSTEMS”; and U.S. Pat. No. 6,841,275 entitled “METHOD AND APPARATUS FOR CONTROLLING VOLTAGE FROM A FUEL CELL SYSTEM,” issued Jan. 11, 2005, are incorporated herein by reference, in their entirety, as are the sections in this specification. Aspects of the invention can be modified, if necessary, to employ systems, circuits and concepts of the various patents, applications and publications to provide yet further embodiments of the invention.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A power system, comprising:
at least one balance of plant (BOP) device;
a power source operable to provide a first amount of power at a power source voltage;
a fuel cell stack operable to provide a second amount of power at a fuel cell stack voltage;
a first voltage controlled element electrically coupled between the power source and the at least one BOP device, and operable to transfer a portion of the first amount of power from the power source to the at least one BOP device when the power source voltage is greater than the fuel cell stack voltage; and
a second voltage controlled element electrically coupled between the fuel cell stack and the at least one BOP device, and operable to transfer a portion of the second amount of power from the fuel cell stack to the at least one BOP device in response to the fuel cell stack voltage being greater than the power source voltage.

2. The power system of claim 1, further comprising:
a first direct current (DC) bus coupled between the power source and the first voltage controlled element, and operable at a DC bus voltage; and
a second DC bus coupled between the at least one BOP device and the second voltage controlled element, and operable at the DC bus voltage when the DC bus voltage is greater than the fuel cell stack voltage, and operable at the fuel cell stack voltage when the fuel cell stack voltage is greater than the DC bus voltage.

3. The power system of claim 2 wherein the power source is coupled to the first DC bus.

4. The power system of claim 2, further comprising:
a direct current to direct current (DC/DC) converter electrically coupled between the fuel cell stack and the first DC bus, and operable to transfer an excess amount of power generated by the fuel cell stack, wherein the excess amount of power corresponds to a difference between the second amount of power generated by the fuel cell stack and the portion of the second amount of power that is transferred to the at least one BOP device.

5. The power system of claim 1 wherein the first voltage controlled element comprises:
a diode comprising an anode electrically coupled to a positive DC voltage terminal of the fuel cell stack and comprising a cathode electrically coupled to the at least one BOP device.

6. The power system of claim 1, further comprising:
a controller coupled to the first voltage controlled element and operable to communicate a first control signal to the first voltage controlled element so that the first voltage controlled element transfers the portion of the first amount of power from the power source to the at least one BOP device in response to the power source voltage being greater than or equal to the fuel cell stack voltage, and controllably coupled to the second voltage controlled element and operable to communicate a second control signal to the second voltage controlled element so that the second voltage controlled element transfers the portion of the second amount of power from the fuel cell stack to the at least one BOP device in response to the fuel cell stack voltage being greater than or equal to the power source voltage.

7. The power system of claim 6 wherein the first voltage controlled element comprises:
a field effect transistor comprising a drain electrically coupled to a positive DC voltage terminal of the fuel cell stack, comprising a source electrically coupled to the at least one BOP device, and comprising a gate electrically coupled to the controller.

8. The power system of claim 6 wherein the first voltage controlled element comprises:
a switch comprising a first terminal electrically coupled to a positive DC voltage terminal of the fuel cell stack, comprising a second terminal electrically coupled to the at least one BOP device, and a third terminal electrically coupled to the controller.

9. The power system of claim 1 wherein the power source comprises:
at least one of a battery or an ultracapacitor.

10. The power system of claim 1 wherein the power source comprises:
an alternating current (AC) machine operable to produce AC power; and
an alternating current to direct current (AC/DC) converter electrically coupled to the AC machine and operable convert the AC power produced by the AC machine into DC power.

11. A power system, comprising:
a fuel cell stack primary power source;
a secondary power source;
a first direct current bus;
a first voltage controlled element that electrically couples power from the secondary power source to the first direct current bus when a voltage across the secondary power source is greater than a voltage across the fuel cell stack primary power source;
a second voltage controlled element that electrically couples power from the fuel cell stack primary power source to the first direct current bus when the voltage across the fuel cell stack primary power source is greater than the voltage across the secondary power source; and
at least one balance of plant load electrically coupled to the first direct current bus.

12. The power system of claim 11, wherein the secondary power source is at least one of a battery, a super capacitor, or an ultracapacitor.

13. The power system of claim 11, wherein at least one of the first and the second voltage controlled elements are diodes.

14. The power system of claim 11, wherein at least one of the first and the second voltage controlled elements are transistors.

15. The power system of claim 11, wherein at least one of the first and the second voltage controlled elements are switches, and further comprising:
at least one controller controllingly coupled to operate the switches.

16. The power system of claim 11, further comprising:
a second direct current bus, electrically coupled to the secondary power source.

17. The power system of claim 16, further comprising:
a direct current to direct current converter coupled between the fuel cell stack primary power source and the second direct current bus and operable to change a voltage from the fuel cell stack primary power source.

18. A power system, comprising:
a power source operable to provide a first amount of power;
a fuel cell stack operable to provide a second amount of power at a fuel cell stack voltage;
at least one balance of plant (BOP) device operable to receive the first amount of power from the power source and operable to receive the second amount of power from the fuel cell stack;
a primary direct current (DC) bus operable to receive at least the first amount of power from the power source and operable at a DC bus voltage;
a first voltage controlled element electrically coupled between the primary DC bus and the at least one BOP device, and operable to transfer at least a portion of the first amount of power from the power source to the at least one BOP device when the DC bus voltage is greater than the fuel cell stack voltage; and
a second voltage controlled element electrically coupled between the fuel cell stack and the at least one BOP device, and operable to transfer at least a portion of the second amount of power from the fuel cell stack to the at least one BOP device in response to the fuel cell stack voltage being greater than the DC bus voltage.

19. The power system of claim 18, further comprising:
a second DC bus coupled between the at least one BOP device and the second voltage controlled element, and operable at the DC bus voltage when the DC bus voltage is greater than the fuel cell stack voltage, and operable at the fuel cell stack voltage when the fuel cell stack voltage is greater than the DC bus voltage.

20. The power system of claim 18 wherein the power source is operable at the first DC bus voltage.

21. The power system of claim 18, further comprising:
a direct current to direct current (DC/DC) converter electrically coupled between the fuel cell stack and the first DC bus, and operable to transfer an excess amount of power generated by the fuel cell stack, wherein the excess amount of power corresponds to a difference between the second amount of power generated by the fuel cell stack and the portion of the second amount of power that is transferred to the at least one BOP device.
